(19) United States
(12) Patent Application Publication
(10) Pub. No.: US 2010/0001065 A1
(43) Pub. Date: Jan. 7, 2010

(54) Library Materials Tagging System and Software Management System and Library Patron Card Reader

(76) Inventors: Michael J. Flesness, Zimmerman, MN (US); Steven G. Gacek, Mahtomedi, MN (US); Larry K. Kopacek, Stacy, MN (US); James K. Nelson, Lindstorm, MN (US)

Correspondence Address: ROBERT A PAJAK;PATENT SERVICES, 14234 NAPLES STREET NE, HAM LAKE, MN, 55304, US

(21) Appl. No.: 12/435,307

(22) Filed: May 4, 2009

Related U.S. Application Data
(60) Provisional application No. 61/050,217, filed on May 3, 2008.

(51) Int. Cl. G06K 5/00

(52) U.S. Cl. 235/380

(57) ABSTRACT

An imager is employed for reading a bar code from patron library card or a library material for subsequent processing and derivation of the bar code for subsequent processing by a library cataloging system.

### CROSS-REFERENCES TO RELATED APPLICATIONS

This application claims the benefit and priority from U.S. Provisional Application No. 61/050,217, filed May 03, 2008, and entitled, “Library Patron Card Reader, EZ Tag System, & CircT Software Library Management,” all of which is incorporated herein in its entirety by reference.

### FIELD OF THE INVENTION

The present invention relates generally to library checkout systems, and more particularly to systems for checking out library materials and management of the materials.

### BACKGROUND OF THE INVENTION

Modern libraries have experienced increased demands from patrons, in terms of needs for larger and larger holdings of books and other tangible materials. Accordingly, it is not uncommon for public libraries, for example, to handle collection and distribution of hundreds of thousands, or even millions, of books and materials. Tasks of librarians in handling these ever increasing volumes are often overwhelming. Librarian tasks involve both receiving materials returned from patrons (“check-in”) and distributing materials to patrons (“check-out”). These tasks, when manually performed by library personnel upon such ever-growing volumes of materials, greatly affects time required to perform the tasks.

Further there have been many advances in cataloging software commonly where information is sent to the library's Integrated Library System (ILS) via the well established Standard Interface Protocol (SIP), both of which will not be described herein. Such systems may incorporate both bar code and/or RFID information associated with both patrons and library circulation materials.

In attempts to respond to needs for automation of check-in and check-out tasks, several techniques, devices, and systems have been proposed. For example, U.S. Pat. No. 5,288,980 issued to Patel, et al., entitled “Library Check Out/Check In System” incorporated herein by reference thereto shows such a system. Thereshown is a “self check out/check in terminal for facilitating independent withdrawal or return of articles having article identifying indicia on opposing surfaces thereof, and alterable security indicia for indicating the circulation status of the article.”

The aforesaid patent employs the common bar code, a computer coding system that uses a printed pattern of lines or bars to identify products, mail and packages, customer accounts, and the like. Bar codes are commonly read by optically scanning the printed pattern and using a computer program to decode the pattern. In a linear bar code system, the code itself contains no information about the item to which it is assigned but represents a string of identifying numbers or letters. When the code is read by an optical scanner linked to a computer, the computer can provide and record information about the item, such as, the item, size, and the like from and to databases.

More particularly, bar code and/or RFID information, more specifically digital information unique to both patrons and library circulation materials, may be routed back and forth from a circulation desk in communication with the aforesaid selected ILS cataloging systems in accordance with a selected SIP protocol, for subsequent display on the check-out station display and/or printed receipt information. It should be noted that both the SIP and ILS are well known and therefore will not be described herein.

Commonly, library patrons have a patron card that includes a bar code as exemplified by the aforementioned patent. Reading of the patron card barcode is generally accomplished by very complex, expensive scanning system that generally requires proper card insertion and orientation, and is less than 100% reliable.

Therefore, there exists a need for a reliable patron card reader and library material bar code reader.

### SUMMARY OF THE INVENTION

It is an object of the present invention to provide a reliable barcode reader for a library patron card.

In accordance with the present invention the bar code associated with the library patron card is imaged by a camera for subsequent conversion to a bar code sequence for subsequent data processing.

### BRIEF DESCRIPTION OF THE DRAWINGS

FIG. 1 is a plan view of a patron check-out circulation desk.

FIG. 2 is an exemplary schematic diagram of the components employed in the bar code reader/processor of the present invention.

### DETAILED DESCRIPTION OF THE INVENTION

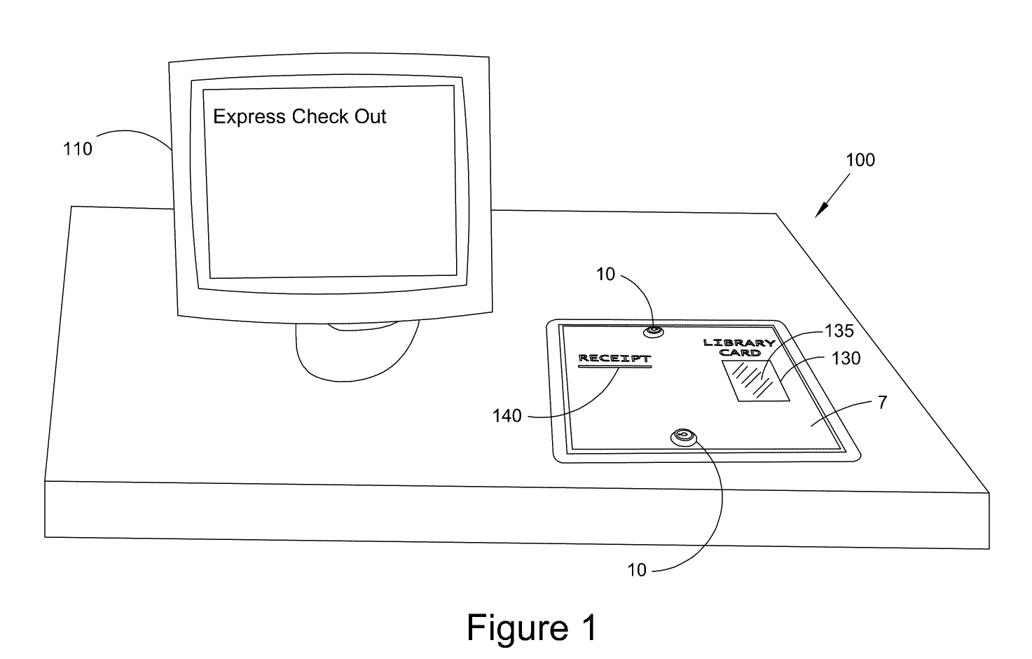

Referring to FIG. 1, thereshown is patron check-out work station 100 including a patron display or monitor 110 for display of current “Express Check Out” information as is well known, and the patron card reader/printer face plate 7 in accordance with present invention.

Face plate 7 includes an aperture 130 having a glass window 135 affixed to, e.g., the back side 7b thereof by, for example, a selected silicone sealant. Also, face plate 7 includes a second aperture or slot 140 configured in both width and length to pass a chosen receipt paper therethrough.

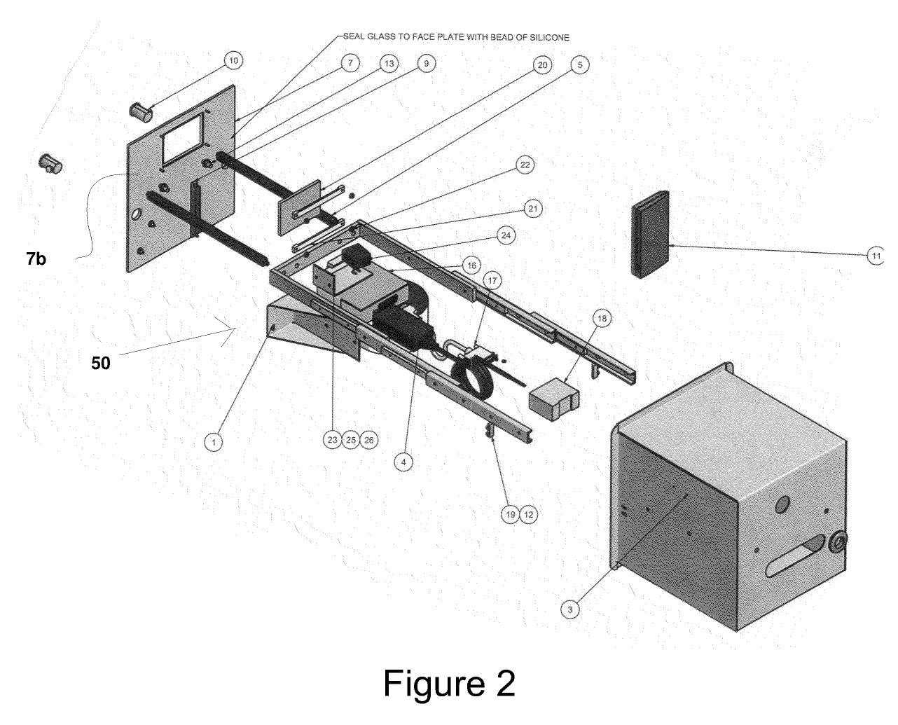

Details of an exemplary mechanism below faceplate 7 are particularly shown in FIG. 2. Face plate 7 is slidably coupled to housing 3 by way of a pair of compression gas springs 5 such that face plate 7 may be raised relative to the work station upon release of key actuated slam action locks 10. One end of each of the springs 5 is fastened to the backside of plate 7, and the other fastened to the frame assembly generally numerically designated by numeral 50, the details of which are well within the art of the mechanical artisan and will only be briefly described herein. In one embodiment, however, frame assembly 50 may be telescopically mounted as illustrated to housing 3 by an arrangement of sliding members for easy access to components mounted thereto.

Mounted to frame assembly 50 is a printer 16, for example, a thermal printer, including associated power supply 4. Fastened to the backside 7b of faceplate 7 is printer paper lip guide 9 for receiving paper from printer 16 all of which are aligned with printer slot 140. A printer data cable 17, for example a USB cable and associated connectors is operably connected to the library ILS for receiving information therefrom to be printed.

Also mounted to frame assembly 50 is a barcode imager 24, for example a CCD (CMOS charge coupled device) imager, similar to present day digital cameras and the like. An example of such an imager is one that has a USB output with a 5.1′ image distance characteristic. As illustrated, imager 24 is coupled to the frame assembly 50 through bracket assemble 23, 25, and 28.

In the standby mode, the entire assembly is contained within housing 3 mounted to workstation 100 with the faceplate 7 secured in position on the work station 100, and the imager 24 being configured and arranged to receive images of barcodes on patron cards or library materials for subsequent processing by image processing (not shown) for deriving the bar code information from the bar code on the patron card or library material at the glass window 135 facing imager 24.

In accordance with the present invention, a method has been described for reading a patron card with associated bar code by way of imaging the bar code as opposed to common complex bar code scanning techniques, thereby avoiding error an increasing reliably by image processing, not herein described.

It should be appreciated that by producing an image of the bar code associated with the patron card or library material eliminates the need for complex scanning, and eliminates the need for bar code orientation requirements, by virtue of only computer processing of an image to determine the bar code for subsequent processing by the ILS.

In turn, the printer may provide the desired receipt after recognition of the patron via the patron card bar code, and the library materials identified by their unique bar code.

It is to be appreciated the exemplary mechanical schematic, particularly frame assembly 50, may be arranged, modified, or added to, or other modifications, all of which are intended to be within the true spirit and scope of the present invention

It should be appreciated that components of the invention aforedescribed may be substituted for other suitable components for achieving desired results, or that various accessories may be added thereto.

Accordingly, these and other various changes or modifications in form and detail from the present invention as described may also be made therein, again without departing from the true spirit and scope of the invention as defined by the appended claims.

We claim:

1. A library material checkout system having a library circulation desk, and wherein patron cards include a unique bar code associated therewith, and where identified patrons and the library circulation materials associated thereto are processed in accordance with a selected cataloging system, the checkout system comprising:
a flush mounted faceplate coupled to the circulation desk, said faceplate including an aperture having a transparent window covering the aperture;
an imager for capturing an image of a patron card barcode facing the imager through the transparent window;
a processor for processing the captured patron card image and deriving the bar code therefrom for subsequent processing by the selected cataloging system.

2. The library material checkout system of claim 1 further comprising:
an printer for receiving information from the selected cataloging system for printing receipt information associated with materials being checked out by the patron; and
where the faceplate further includes an aperture for passing the printed receipt information therethrough from the printer.

3. The library material checkout system of claim 1 where said imager captures bar code images associated with library materials intended to be checked out.

4. The library material checkout system of claim 1 where the transparent window is glass.

5. A method of accessing bar code information at a library material checkout system library circulation desk, and wherein patron cards include a unique bar code associated therewith, and where identified patrons and the library circulation materials associated thereto are processed in accordance with a selected cataloging system, the method comprising:
placing a patron card with a unique bar code thereon on a window of a flush mounted faceplate coupled to the circulation desk, the faceplate including an aperture having a transparent window covering the aperture;
capturing an image of the patron card barcode facing the imager through the transparent window;
processing the captured patron card image and deriving the bar code therefrom for subsequent processing by the selected cataloging system.
